(19) United States
(12) Patent Application Publication
(10) Pub. No.: US 2007/0006460 A1
(43) Pub. Date: Jan. 11, 2007

(54) Method of manufacturing header pipe, header pipe and heat exchanger with header pipe

(76) Inventor: Jae Hoon Kim, Chun Ahn City (KR)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/478,825

(22) Filed: Jun. 30, 2006

(30) Foreign Application Priority Data
Jul. 5, 2005 (KR) 10-2005-0060162

(51) Int. Cl. F28F 9/02; B21D 53/00; B23P 15/26

(52) U.S. Cl. 29/890.043; 29/890.045; 165/173

(57) ABSTRACT

A method of manufacturing a header pipe for a heat exchanger, including (a) forming a header pipe as a single body with a vertically separating panel between first and second channels, including a plurality of slots through the pipe adapted to connect to cooling fluid tubes of a heat exchanger, (b) introducing a punch into the inside of one of the channels of the header pipe with more than one nipple facing one side of the separating panel, (c) inserting a die into the inside of the other of the channels of the header pipe with punching holes aligned with the punching nipples and the other side of the separating panel, (d) inserting a pressuring pole of a pressuring device through the header pipe slots into the one channel, and (e) moving the pressuring pole to press the punch toward the separating panel to punch more than one hole into the separating panel.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to heat exchangers, and more particularly to manufacturing heat exchanger header tanks having separating panels with penetrating holes.

### BACKGROUND OF THE INVENTION AND TECHNICAL PROBLEMS POSED BY THE PRIOR ART

A prior art heat exchanger with header tanks is illustrated in FIG. 1, with FIG. 2 showing an exploded perspective view of one header tank. Specifically, as shown in FIG. 1, the heat exchanger 20 includes an upper header tank 22; the lower header tank 24; the numerous tubes 26 that are arranged in a row between the upper header tank 22 and the lower header tank 24; the cooling fins 28 between the tubes 26.

FIG. 2 shows the prior art upper header tank 22 upside down to provide a clear view of the disassembled structure. The upper header tank 22 includes:
a. a main body 30 extruded with the open top having a U shape;
b. a header plate 32 covering the top of the main body 30, and including slots 33 therein for mounting the tubes 26;
c. a separating panel 34 vertically separating the inside space of the main body 30 placed in the horizontal direction;
d. a center baffle 35 located in the middle of the main body 30 and separating the inner space of the main body 30 horizontally;
e. a pair of the end baffles 36 vertically closing the two ends of the main body 30.
   In addition, sills 38 are formed at both horizontal edges of the main body 30, and both sides of the header plate 32 are rested on the sills 38 placed inside of the top edges 40 of the main body 30.

Further, the end baffle 36 is placed on one end of the main body 30 and includes an inflow hole 42 for the inflow of the cooling fluid and an exhaust hole 44 for the outflow of the cooling fluid. The other end baffle 36 closing the other end of the main body 30 prevents either inflow or outflow of the cooling fluid from that end of the main body 30. The separating panel 34 is formed with a number of the penetrating holes 46 in the section between the center baffle 35 towards one end of the main body 30 for the purpose of allowing the cooling fluid to pass through.

With this structure, after the cooling fluid flows into one side of the upper header tank 22, it passes through the tubes 26, reaching one side of the lower header tank 24. After the cooling fluid moves to the other side of the lower header tank 24, it enters the other side of the upper header tank 22, passing through tubes 26 again. The cooling fluid flowing into the other side of the upper header tank 22 passes through the penetrating holes 46 of the separating panel 34. Then the cooling fluid in one side of the lower header tank 24 through the tubes 26 and the cooling fluid in one side of the upper header tank 22 passes through the tubes 26. After the cooling fluid cools down while it passes through each header tank (22, 24) and the tubes 26, it flows out through one side of the upper header tank 22.

Unfortunately, it is difficult to punch the penetrating holes 46 in the traditional header tank 22 such as described above after the separating panel 34 is inserted to the main body 30 and the header plate 32. This becomes very difficult because the width and the height of the inner space separated by the separating panel 34 are very narrow, both being approximately 25 mm. Thus, the main body 30, the header plate 32 and the separating panel 34 have been manufactured separately, with the traditional header tank 22 made by joining them altogether. Interconnecting grooves and slots 50 (see FIG. 2) are required to assist in properly securing the components together, but nonetheless all form joints which are susceptible to failure and/or leakage. This method not only increases the number of manufacturing process steps and the number of parts, but it also has the weakness of potentially damaging each part during the brazing process when the parts are joined together.

In addition, due to possible damage of each part during the joining process, there is the possibility that leakage of the cooling fluid from the joined section of the separating panel 34 might result.

The present invention is directed toward overcoming one or more of the problems set forth above.

### SUMMARY OF THE INVENTION

According to one aspect of the present invention, a method of manufacturing a header pipe for a heat exchanger is provided, including (a) forming a header pipe as a single body with a vertically separating panel between first and second channels, including a plurality of slots through the pipe adapted to connect to cooling fluid tubes of a heat exchanger, (b) introducing a punch into the inside of one of the channels of the header pipe with more than one nipple facing one side of the separating panel, (c) inserting a die into the inside of the other of the channels of the header pipe with punching holes aligned with the punching nipples and the other side of the separating panel, (d) inserting a pressuring pole of a pressuring device through the header pipe slots into the one channel, and (e) moving the pressuring pole to press the punch toward the separating panel to punch more than one hole into the separating panel.

In one form of this aspect of the present invention, prior to the step of moving the pressure pole, a plurality of contacting poles of a contacting device are inserted through the header pipe slots into the other channel, and the contacting poles are moved to position the die in contact with the other side of the separating panel. In a further form, the thickness of the pressuring pole and the contacting poles is smaller than the width of the slots.

In another form of this aspect of the present invention, the more than one punch nipples are arranged along the longitudinal direction of the separating panel.

In still another form of this aspect of the present invention, the pressuring device includes a plurality of pressuring poles, and, in the pressure pole inserting step, each pressure pole is inserted through different slots.

In yet another form of this aspect of the present invention, the one channel of the heater pipe is the upper liquid channel according to the intended direction of the liquid passing the holes punched in the separating panel, and the other channel is the lower liquid channel.

In another form of this aspect of the present invention, after the moving step, each end of the header pipe is closed with a first end baffle and a second end baffle.

In still another form of this aspect of the present invention, the punch includes an elastic member adapted to bias the punch away from the separating panel.

In yet another form of this aspect of the present invention, the cross section of the punching nipples has a round shape. In one further form, the punch includes an elastic member adapted to bias the punch away from the separating panel. In another further form, after the moving step, the header pipe is finished including closing each end of the header pipe with a first end baffle and a second end baffle and, in a still further form, the finishing step includes separating the section of the header pipe horizontally by inserting the center baffle into the baffle insertion slot.

In another aspect of the present invention, a header pipe made as described above has both ends covered by joined first and second end baffles.

In one form of this aspect of the present invention, the header pipe has a baffle insertion slot in the middle having its longitudinal extension in the horizontal direction, and the header pipe includes a center baffle in the baffle insertion slot separating the first channel and the second channel horizontally.

In another aspect of the present invention, a heat exchanger is provided, including upper and lower header tanks each having a header pipe having first and second channels, at least one of the header pipes being made as described above. A plurality of tubes extend between the upper and lower header pipes with one end of each tube secured in one of the slots in the upper header pipe and the other end of each tube secured in one of the slots in the lower header pipe. Cooling fins are between the tubes.

According to one form of this aspect of the present invention, an inflow hole is in the first end baffle for introducing cooling fluid to one of the channels and an exhaust hole is in the wall of the header pipe adjacent the first end baffle for discharging cooling fluid from the other of the channels.

### BRIEF DESCRIPTION OF THE DRAWINGS

FIG. 1 is a perspective view of the traditional heat exchanger partially broken away to show internal construction;

FIG. 2 is an exploded perspective view of a traditional header tank;

FIG. 3 is an exploded perspective view of a heat exchanger incorporating the present invention;

FIG. 4 is a perspective view of the header pipe according to the present invention made by an extrusion process;

FIG. 5 is a perspective view of the header pipe with slots, baffle insertion hole and the exhaust hole;

FIG. 6 is a perspective view illustrating the insertion of the punch and the die into the header pipe according to the present invention;

FIG. 7 is a perspective view illustrating the insertion of the punch and the die as well as the partial insertion of the pressuring device and the contacting device into the header pipe according to the present invention;

FIG. 8 is a horizontal cross-sectional view showing the insertion of the punch and the die as well as the partial insertion of the pressuring device and the contacting device;

FIG. 9 is a horizontal cross-sectional view similar to FIG. 8, but with the die contacting the separating panel inside of the header pipe;

FIG. 10 is a horizontal cross-sectional view similar to FIG. 9 illustrating punching of the penetrating holes on the separating panel.

### DETAILED DESCRIPTION OF THE INVENTION

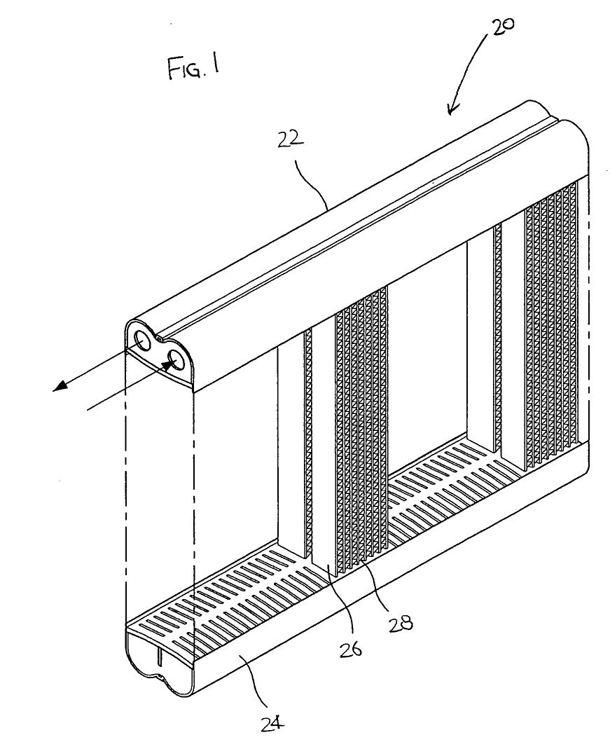

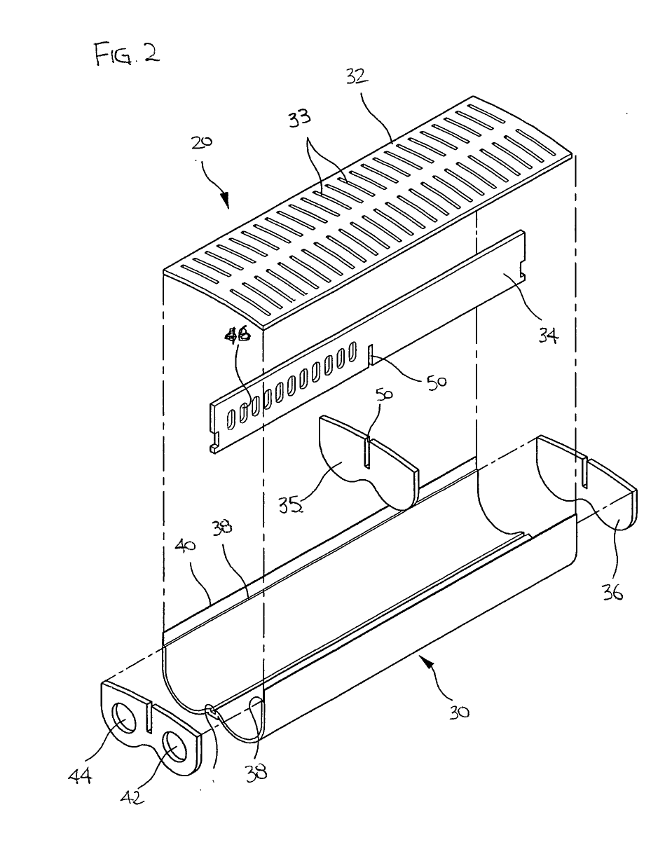

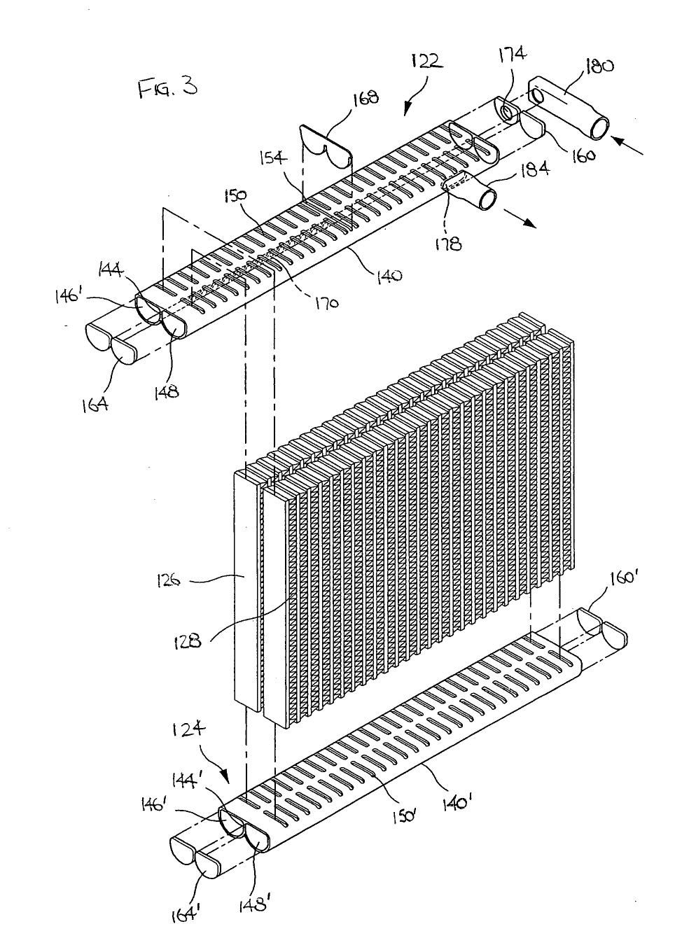

The manufacturing process of the heat exchanger 120 and the header tank 122 according to this invention is explained below with reference to the attached FIGS. 3-10. The general structure of the heat exchanger 120 and header tank 122 produced from this method is like the prior art structures illustrated in FIGS. 1-2 and described herein.

Specifically, FIG. 3 is a disassembled perspective view of the heat exchanger 120 manufactured according to this invention, wherein the upper header tank 122 and the lower header tank 124 face each other, and a plurality of tubes 126 are arranged in a row between the upper header tank 122 and the lower heat tank 124, with cooling fins 128 between the tubes 126. The tubes 126 and the cooling fins 128 are identical to the tubes 126 and the cooling fins 128 of the traditional heat exchanger. Also, the flow direction of the cooling fluid is same as in the traditional heat exchanger as previously described.

The upper header tank 122 includes a header pipe 140 formed in a single body with the separating panel 144 which separates the inner space vertically, creating first and second channels 146, 148. Advantageously, both the width and the height of both channel 146, 148 are below 25 mm.

One outer surface is punched with numerous slots 150 horizontally and the baffle insertion slot 154 in the middle. The first end baffle 160 and the second end baffle 164 cover the two ends of the header pipe 140, and the center baffle 168 inserted to the baffle insertion slot 154 horizontally separates the first channel 146 and the second channel 148.

The separating panel 144 has the numerous penetrating holes 170 concentrated towards the second end baffle 164. The center baffle 168 is inserted into the baffle insertion slot 154 located in the middle of the header pipe 140, separating the first channel 146 and the second channel 148 horizontally.

For the purpose of introducing the cooling fluid, an inflow hole 174 is made in the first end baffle 160 in the section that is opposite the first channel 146. For the purpose of the cooling fluid outflow, an exhaust hole 178 is formed on the wall of the second channel 148 near to the joining section of the first end baffle 160. An inflow pipe 180, which supplies the cooling fluid, is connected to the inflow hole 174, and an exhaust pipe 184, which collects the cooling fluid, is connected to the exhaust hole 178. It should be appreciated that the inflow pipe 180 and the exhaust pipe 184 may be advantageously connected perpendicularly to the longitudinal direction of the header pipe 140 as illustrated in FIG. 3 so that shortening of the total length of the heat exchanger may be attained.

The lower header tank 124 includes the header pipe 140′, which is formed into a single body, consisting of the separating panel 144′, which divides the first channel 146′ and the second channel 148′ horizontally. Its outer top side has numerous slots 150′ in the horizontal direction, and the first and second end baffles 160′, 164′ cover each end of the header pipe 140′.

It should also be appreciated that, in cases where numerous fluid passes are needed, more than one center baffle can be formed in the first channel and the second channel of both the upper header tank and the lower header tank. In that case, the locations of the penetrating holes on the separating panel can be on the left, on the right, at the center or at both ends of the separating panel either in the upper or the lower header tank according to the requirements of the cooling fluid flow direction.

The width and the height of the first channel 146 and the second channel 148 of the header tank 122 are very narrow, being less than 25 mm. Thus, it is difficult to use the conventional punch 200 to punch the penetrating holes 170 into the separating panel 144. Especially when there are many penetrating holes 170, as shown in FIG. 3, punching of the penetrating holes 170 presents particular difficulties.

Accordingly, according to the present invention, the header pipe 140 uses a special process to punch the penetrating holes 170 into the separating panel 144, which process for manufacturing the header pipe 140 is explained below with reference to the attached figures.

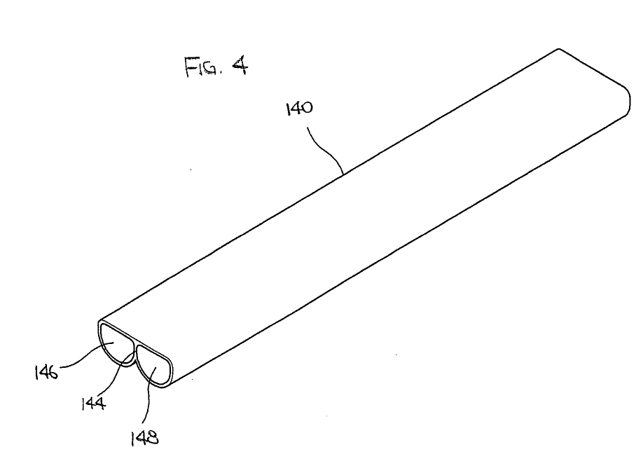

FIG. 4 is a perspective view of the header pipe made using an extrusion process. When the header pipe 140 is manufactured, it is first advantageously extruded into a single body having a separating panel 144 which vertically separates the first channel 146 and the second channel 148. By using an extrusion process to make the header pipe 140, the productivity is much increased compared to the traditional header tank manufacturing process which produces the main body 30, the header plate 32 and the separating panel 34 individually as previously described. Also, when the separating panel 144 is made in a single body as shown in FIG. 4, the first channel 146 and the second channel 148 are completely separated, thereby eliminating the possibility of leakage of the cooling fluid through the separating panel 144 and gaining the advantage of minimizing the concern of damage of the separating panel 144 even if it is used for a long period of time.

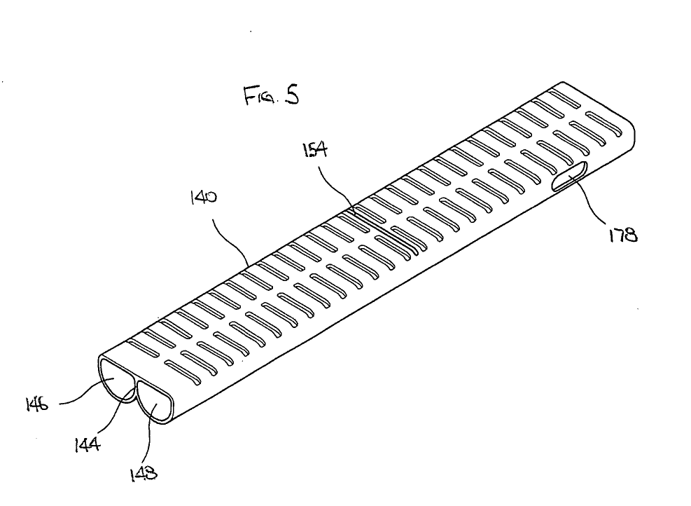

FIG. 5 illustrates the header pipe 140 with the plurality of slots 150, the baffle insertion slot 154 and the exhaust hole 178. When the manufacturing of the header pipe 140 as shown on the FIG. 4 is completed, the plurality of slots 150 are arranged in a row on one side of the outer surface in the horizontal direction as shown on the FIG. 5. The baffle insertion slot 154, with its longitudinal direction horizontal, is formed in the middle, and an exhaust hole 178 is made on one end.

It should be appreciated, therefore, that the baffle insertion slot 154 and the exhaust hole 178 may be made simultaneously. However, it should also be appreciated that the baffle insertion slot 154 and the exhaust hole 178 can be made when the center baffle 168 and the exhaust pipe 184 are connected.

Also, in order to prevent leakage of the cooling fluid between the first channel 146 and the second channel 148, the plurality of slots 150 should be made in two rows into the first channel 146 and the second channel 148 parallel to each other as shown on the FIG. 5.

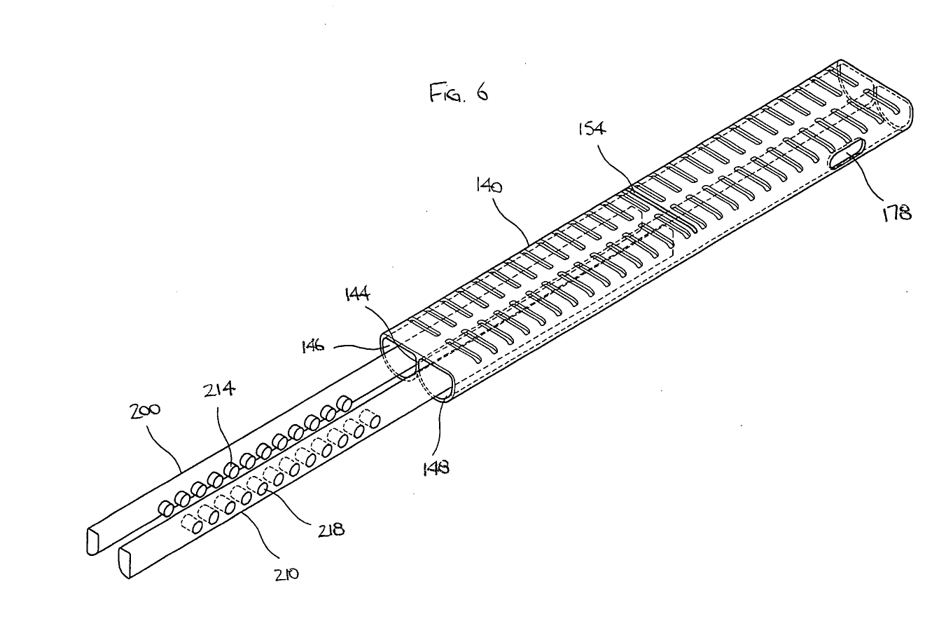

FIG. 6 illustrates the insertion of the punch and the die into the header pipe. According to the header pipe manufacturing process of the present invention, the penetrating holes 170 in the separating panel 144 are advantageously formed using the slender punch 200 and the die 210 that can be inserted into the first channel 146 and the second channel 148. The punch 200 has the same number of punching nipples 214 on one side as the number of the penetrating holes 170 of the separating panel 144. The die 210 has the punching holes 218 with a shape that makes insertion of the punching nipples 214 possible and each hole is separated with the same spacing as of the punching nipples 214.

The punch 200 is inserted into the first channel 146 with the ends of the punching nipples 214 facing one side of the separating panel 144. The die 210 is inserted into the second channel 148 between the separating panel 144 and the punching holes 218, facing the punching nipples 214. The insertion locations of the punch 200 and the die 210 can, however, be switched. The insertion location of the punch 200 may advantageously be in the upper channel from which the cooling fluid flows through the penetrating holes, with the die 210 be inserted into the lower channel so that the cooling fluid flows smoothly by the way of the penetrating holes 170 formed while punching.

In this illustrated embodiment, the header pipe 140 is fixed while the punch 200 and the die 210 are slid into the header pipe 140. However, the punch 200 and the die 210 may alternatively be fixed while sliding into the header pipe 140. In other words, the method of the insertion of the punch 200 and the die 210 into the header pipe 140 can be altered according to the structures of the punch 200 and the die 210.

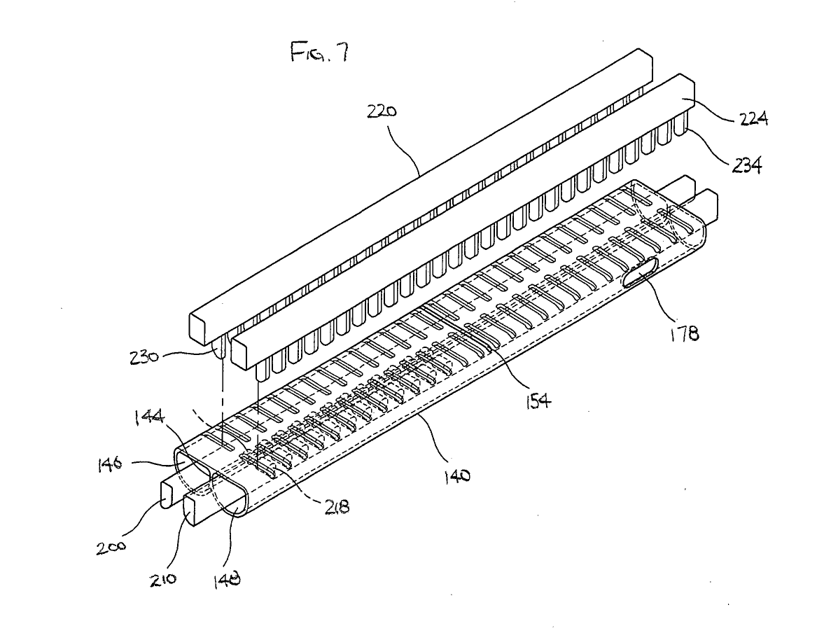

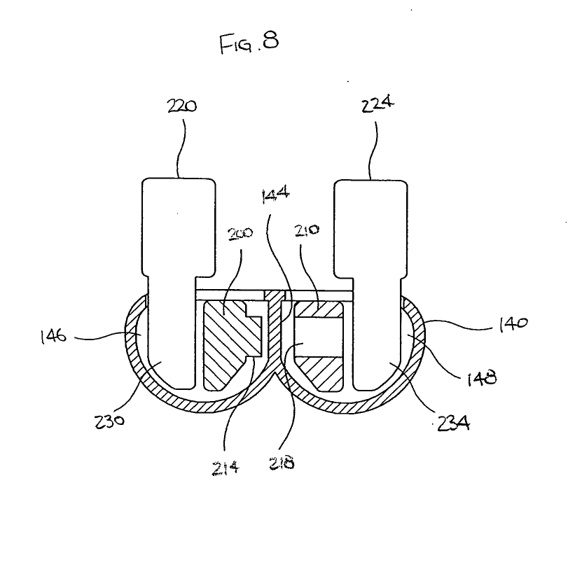

FIG. 7 illustrates the insertion of the punch 200 and the die 210 as well as the partial insertion of the pressuring device 220 and the contacting device 224 into the header pipe 140. FIG. 8 is a horizontal cross-sectional view showing the insertion of the punch 200 and the die 210 as well as the partial insertion of the pressuring device 220 and the contacting device 224. Pressuring poles 230 (see FIG. 7) are formed at the bottom of the pressuring device 220 in order to penetrate into the slots 150. Contacting poles 234 are formed at the bottom of the contacting device 224 in order to also penetrate into aligned slots 150.

After the punch 200 and the die 210 are inserted completely, the pressuring device 220 and the contacting device 224 are moved downward, with the pressuring poles 230 being inserted between the inner surface of the header pipe 140 and the punch 200, as shown in FIG. 8, and the contacting poles 234 inserted between the inner surface of the header pipe 140 and the die 210.

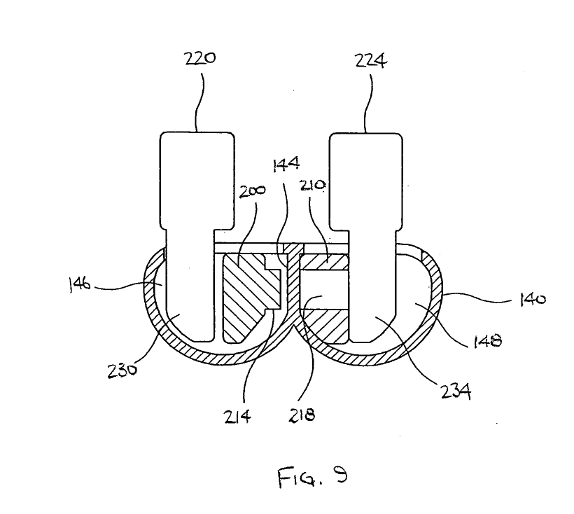

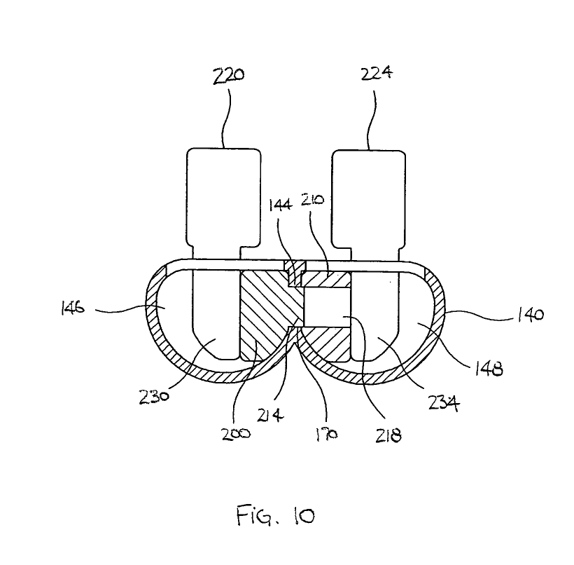

Once the pressuring poles 230 and the contacting poles 234 are completely inserted into the header pipe 140, the contacting device 224 moves horizontally toward the separating panel 144, pushing the die 210 toward the separating panel 144 inside the header pipe 140 until it firmly contacts the separating panel 144 as shown in FIG. 9. At that point, the pressuring device 220 is moved horizontally toward the separating panel 144 and, at the same time, the punch 200 is pushed by the pressuring poles 230 to contact the separating panel 144 firmly. As shown in FIG. 10, the punching nipples 214 then of the punch 200 penetrate through the separating panel 144, with their edges inserted into the punching holes 218, thereby creating the penetrating holes 170 in the separating panel 144.

Moreover, the punching holes 218 may be advantageously formed to the shape of the penetrating holes 170 so that, during the punching process, the chips from the separating panel 144 may be received in the holes 218 and thereafter easily withdrawn out of the die 210.

The punch 200 and the die 210 could also be moved directly without using the pressuring device 220 and the contacting device 224, by pushing together both ends of the punch 200 and the die 210 that stick out of the header pipe 140. In that case, however (with both ends of the punch 200 and the die 210 pushed by putting the forces only at the ends), then the end sections of the punch 200 and the die 210 receive greater force, while the middle section of the punch 200 and the die 210 which is further away from the main force will not be pressured with great force. Therefore, while the penetrating holes 170 are formed properly at the end section of the separating panel 144, the penetrating holes 170 at the middle section of the separating panel 144 may not be formed as advantageously.

It should thus be appreciated that a pressuring device 220 having numerous pressuring poles 230 which force the punch 200 as described will advantageously provide an evenly distributed force to each section of the punch 200. Similarly, the numerous contacting poles 234 of the contacting device 224 will cause the die 210 to firmly contact the separating panel 144 with an evenly distributed force to each section of the die 210. Thus, while punching, if the pressuring device 220 and the contacting device 224 are used, the penetrating holes 170 can be properly created on the separating panel 144 on all sections of it.

If the punch 200 and the die 210 are fixed, then the header pipe 140 can be moved to create the penetrating holes 170. In this case, without using the contacting device 234, after the die 210 is pushed in so as to contact the separating panel 144 firmly, a punching force is applied to the pressuring poles 230 of the pressuring device 220 whereby the penetrating holes are created by the punching nipples 214.

The manufacturing method of the header pipe 140 according to this invention has the advantage of radically increasing the productivity because numerous penetrating holes 170 are created at one time. Furthermore, should the different size and the alternative arrangement of the penetrating holes 170 of the separating panel 144 be required, the method has the advantage of creating penetrating holes 170 at one time by changing the shape, the number and the arrangement of the punching nipples 214 of the punch 200.

The punch 200 may have an elastic device (not shown) which provides elasticity pushing the punch 200 away from the separating panel 144 so that, when the outside force is removed from the pressuring device 220 after forming the penetrating holes 170, the punch 200 will return back to the original position and away from the separating panel 144 as shown on the FIG. 8. Thereafter, the manufacturer may easily withdraw the punch 200 and the die 210 from the header pipe 140, thus facilitating productivity.

It should thus be appreciated that when the manufacturing method of the header pipe 140 according to this invention is used, the outer surfaces of the channels 146, 148 and the separating panel 144 can be made into a single body, and then numerous penetrating holes 170 can be made in the separating panel 144 at one time. As a result, the manufacturing process is advantageously simplified, production costs are reduced and manufacturing productivity is increased. Moreover, the header tank 140 so manufactured may reliably be free of leaks of the cooling fluid during operation, with the liquid channels 146, 148 completely separated.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A method of manufacturing a header pipe for a heat exchanger, comprising the steps of:
forming a header pipe as a single body with a vertically separating panel between first and second channels, including a plurality of slots through said pipe adapted to connect to cooling fluid tubes of a heat exchanger;
introducing a punch into the inside of one of the channels of the header pipe with more than one nipple facing one side of the separating panel;
inserting a die into the inside of the other of the channels of the header pipe with punching holes aligned with the punching nipples and the other side of the separating panel;
inserting a pressuring pole of a pressuring device through the header pipe slots into said one channel;
moving said pressuring pole to press said punch toward the separating panel to punch more than one hole into the separating panel.

2. The method of claim 1, further comprising, prior to said step of moving said pressure pole, inserting a plurality of contacting poles of a contacting device through the header pipe slots into said other channel, and moving said contacting poles to position said die in contact with said other side of said separating panel.

3. The method of claim 2, wherein the thickness of said pressuring pole and said contacting poles is smaller than the width of said slots.

4. The method of claim 1, wherein said more than one punch nipples are arranged along the longitudinal direction of said separating panel.

5. The method of claim 1, wherein said pressuring device includes a plurality of pressuring poles, and, in said pressure pole inserting step, each pressure pole is inserted through different slots.

6. The method of claim 1, wherein said one channel of said heater pipe is the upper liquid channel according to the intended direction of the liquid passing the holes punched in the separating panel, and said other channel is the lower liquid channel.

7. The method of claim 1, further comprising, after the moving step, closing each end of the header pipe with a first end baffle and a second end baffle.

8. The method of claim 1, wherein said punch includes an elastic member adapted to bias said punch away from said separating panel.

9. The method of claim 1, wherein the cross section of the punching nipples has a round shape.

10. The method of claim 9, further comprising, after the moving step, finishing said header pipe including closing each end of the header pipe with a first end baffle and a second end baffle.

11. The method of claim 10, wherein said finishing step includes separating the section of the header pipe horizontally by inserting the center baffle into said baffle insertion slot.

12. The method of claim 9, wherein said punch includes an elastic member adapted to bias said punch away from said separating panel.

13. A header pipe manufactured by the method of claim 1, wherein both ends of said header pipe are covered by joined first and second end baffles.

14. The header pipe of claim 13, wherein said header pipe has a baffle insertion slot in the middle having its longitudinal extension in the horizontal direction, and said header pipe includes a center baffle in said baffle insertion slot separating the first channel and the second channel horizontally.

15. A heat exchanger comprising:
upper and lower header tanks each having a header pipe having first and second channels, at least one of said header pipes being according to claim 13;
a plurality of tubes extending between said upper and lower header pipes with one end of each tube secured in one of said slots in the upper header pipe and the other end of each tube-secured in one of said slots in the lower header pipe; and
cooling fins between said tubes.

16. The heat exchanger of claim 15, further comprising an inflow hole in said first end baffle for introducing cooling fluid to one of said channels and an exhaust hole in the wall of said header pipe adjacent said first end baffle for discharging cooling fluid from the other of said channels.
